(19) United States
(12) Patent Application Publication
(10) Pub. No.: US 2023/0357539 A1
(43) Pub. Date: Nov. 9, 2023

(54) Fiber Reinforced Thermoplastic Polymer Composition With Flame Retardant Properties

(71) Applicant: Celanese International Corporation, Irving, TX (US)

(72) Inventors: David W. Eastep, Winona, MN (US); Aaron H. Johnson, Winona, MN (US)

(21) Appl. No.: 18/312,134

(22) Filed: May 4, 2023

Related U.S. Application Data
(60) Provisional application No. 63/339,265, filed on May 6, 2022.

(51) Int. Cl. C08K 7/14; C08K 5/50; C08K 5/20; C08L 77/10; C08K 3/32

(52) U.S. Cl. CPC C08K 7/14; C08K 5/50; C08K 5/20; C08L 77/10; C08K 3/32; C08K 2003/328; C08K 2201/014; C08L 2201/02; C08L 2203/20

(57) ABSTRACT

A long fiber-reinforced polymer composition is disclosed having excellent flame retardant properties, optionally in combination with long-term heat stability. The flame retardant composition can include a flame retardant system comprised of only two flame retardant components. The composition can display excellent flame resistant properties at extremely small thicknesses. The composition can also contain a stabilizer package that dramatically improves heat aging properties.

### RELATED APPLICATIONS

The present application is based upon and claims priority to U.S. Provisional Application Ser. No. 63/339,265, having a filing date of May 6, 2022, which is incorporated herein by reference.

### BACKGROUND

Long fiber-reinforced polymer compositions are often employed in molded parts to provide improved mechanical properties. Typically, such compositions are formed by a process that involves extruding a polymer through an impregnation die and onto a plurality of continuous lengths of reinforcing fibers. The polymer and reinforcing fibers are pulled through the die to cause thorough impregnation of individual fiber strands with the resin.

Molded articles formed from long fiber-reinforced polymer compositions can offer various advantages and benefits. For instance, the compositions are not only well suited to producing articles having all different types of shape, but are also well suited to producing articles having excellent mechanical properties, including tensile strength. Consequently, long fiber-reinforced polymer compositions are well suited for use in emerging markets. For instance, the reinforced polymer compositions are well suited for producing electrical components and housings designed for use in electric vehicles. In addition, the reinforced polymer compositions are well suited for producing electronic modules, particularly housings for printed circuit boards, antennae elements, radio frequency devices, sensors, transmitting elements, cameras, global positioning devices, and the like that may be used in LTE or 5G systems.

One problem faced by those skilled in the art in producing long fiber-reinforced articles is making the products flame resistant. Although almost a limitless variety of different flame retardants are marketed and sold commercially, selecting an appropriate flame retardant for a particular fiber-reinforced product is difficult and unpredictable. Further, many available flame retardants contain halogen compounds, such as bromine compounds, which can produce harsh chemical gases during production. Antimony trioxide is also used as a synergist with halogenated systems. This compound contains levels of arsenic and lead. In view of the above, a need exists for a flame retardant composition that is compatible with a fiber-reinforced polymer product, and particularly a long fiber-reinforced polymer product. A need also exists for a flame retardant composition for incorporation into a fiber-reinforced polymer product that is halogen-free. In addition, a need further exists for a long fiber-reinforced polymer composition that not only has flame retardant properties but also displays improved heat stability.

### SUMMARY

In general, the present disclosure is directed to long fiber-reinforced polymer compositions that contain a flame retardant system that exhibits excellent flame resistance even at small thicknesses. In addition, the flame retardant system can be combined with a stabilizer package to dramatically improve heat stability.

In accordance with one embodiment of the present invention, a fiber-reinforced polymer composition is disclosed that comprises from about 30 wt. % to about 90 wt. % of a polymer matrix that contains at least one thermoplastic polymer and from about 10 wt. % to about 70 wt. % of a plurality of long reinforcing fibers that are distributed within the polymer matrix. The fiber-reinforced polymer composition further contains a flame retardant system. The flame retardant system includes a metal phosphinate and a synergist. In accordance with the present disclosure, the synergist comprises a melamine metal phosphate or a melamine poly(metal phosphate). In one embodiment, the flame retardant system can be present in the polymer composition in an amount greater than about 12%, such as greater than about 15%, such as greater than about 18.5% by weight. The polymer composition can also be formulated to be free of zinc borate or other similar salts. The polymer composition can be formulated to exhibit a VO rating as determined in accordance with UL 94 at a thickness of only 2 mm, such as only 1 mm, such as only 0.8 mm, such as only 0.4 mm. In addition, the polymer composition can be formulated to display a comparative tracking index of 600 volts or more as determined in accordance with IC 60112:2020.

In one embodiment, the metal phosphinate has the general formula (I) and/or formula (II):

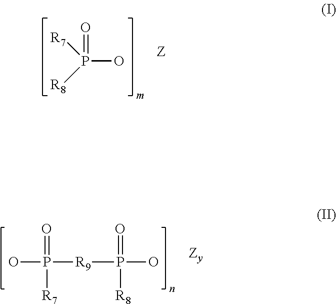

wherein, R₇ and R₈ are, independently, hydrogen or substituted or unsubstituted, straight chain, branched, or cyclic hydrocarbon groups having 1 to 6 carbon atoms; R₉ is a substituted or unsubstituted, straight chain, branched, or cyclic C₁-C₁₀ alkylene, arylene, arylalkylene, or alkylarylene group; Z is Mg, Ca, Al, Sb, Sn, Ge, Ti, Zn, Fe, Zr, Ce, Bi, Sr, Mn, Li, Na, K, and/or a protonated nitrogen base; y is from 1 to 4; n is from 1 to 4; and m is from 1 to 4. The metal phosphinate can be present in the polymer composition in an amount from about 10% by weight to about 20% by weight, such as from about 12.5% by weight to about 16% by weight. In one aspect, the synergist comprises melamine poly(zinc phosphate). The synergist can be present in the polymer composition in an amount from about 4% by weight to about 12% by weight, such as from about 6.5% by weight to about 9% by weight.

In addition to a flame retardant system, the polymer composition can contain a stabilizer package that can provide various advantages and benefits. The stabilizer package can comprise an antioxidant, a heat stabilizer, and optionally a light stabilizer. The heat stabilizer can comprise, for instance, a copper complex. A heat stabilizer well suited for use in the present disclosure is iodobis(triphenylphosphino) copper. In general, any suitable antioxidant can be combined with a heat stabilizer. In one aspect, the antioxidant comprises a reaction product of 2,4-di-tert-butylphenol, phosphorous trichloride, and 1,1′-biphenyl. When present, the light stabilizer can comprise a hindered amine light stabilizer. For instance, the light stabilizer may comprise a benzendicarboxamide.

The stabilizer package incorporated into the polymer composition can dramatically improve the heat aging properties of the composition. For example, after being heat aged at 200° C. for 1,500 hours, the polymer composition can exhibit a drop in notched Charpy impact strength resistance of less than about 50%, such as less than about 40%. Similarly, the tensile strength can decrease no more than about 50%, such as by less than about 40%.

The thermoplastic polymer contained in the polymer composition can be any suitable thermoplastic polymer that is compatible with the other components. The thermoplastic polymer, for instance, can be a polyamide, a polyarylene sulfide, a polyaryletherketone, a polyimide, a polyamide, or mixtures thereof. In one aspect, the thermoplastic polymer comprises one or more polyamides. The one or more polyamides present in the polymer composition can be one or more aliphatic polyamides alone or in combination with a semi-aromatic polyamide or a wholly aromatic polyamide. Aliphatic polyamides that may be present in the polymer composition include nylon-6, nylon-6,6, copolymers thereof, or combinations thereof.

All different types of polymer articles can be molded from the polymer composition of the present disclosure. In one embodiment, a composite tape can be formed from the fiber-reinforced polymer composition. The tape can include a plurality of long reinforcing fibers that are continuous and unidirectionally oriented with in the polymer matrix. The fibers can be present in the tape in an amount of from about 50% to about 70% by weight. In one aspect, the tape can be over molded with a fiber-containing composition.

The polymer composition is particularly well suited to being molded into a component of an electrical device. The electrical device, for instance, can include an electrically conductive component surrounded by a molded polymer component formed from the polymer composition of the present disclosure.

In one embodiment, the electrical device can be an electrical connector that comprises opposing walls between which a passageway is defined for receiving a contact pin. At least one of the walls can be made from the flame retardant polymer composition as described above. In one particular embodiment, the electrical connector can comprise a high voltage powertrain or charging connector or housing for an electric vehicle.

In another embodiment, the fiber-reinforced polymer composition of the present disclosure can be used to produce a housing for an electronic module. The housing can be configured to receive at least one electronic component. The electronic component can comprise an antennae element configured to transmit and receive 5G radio frequency signals. The electronic component can also alternatively include a fiber optic assembly for receiving and transmitting light pulses. In still another aspect, the electronic component can include a camera. In still another embodiment, the polymer composition comprises a structural component of a battery, such as a side support, a cover, a separator, or a bottom support.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic illustration of one embodiment of a system that may be used to form the polymer composition of the present invention;

FIG. 2 is a cross-sectional view of an impregnation die that may be employed in the system shown in FIG. 1;

FIG. 3 is an exploded perspective view of one embodiment of an electronic module that may employ the polymer composition of the present invention;

FIG. 4 depicts one embodiment of a 5G system that may employ an electronic module as shown in FIG. 3; and

FIG. 5 is a perspective view of one embodiment of a housing for an electrical device made in accordance with the present disclosure, such as the housing of a circuit breaker.

### DETAILED DESCRIPTION

It is to be understood by one of ordinary skill in the art that the present discussion is a description of exemplary embodiments only and is not intended as limiting the broader aspects of the present invention.

Generally speaking, the present invention is directed to a fiber-reinforced polymer composition for use in a variety of different applications including use in electronic devices and systems. The composition comprises a polymer matrix that contains a thermoplastic polymer and a plurality of long reinforcing fibers that are distributed within the polymer matrix. Through careful selection of the particular nature and concentration of the components of the polymer composition, the present inventors have discovered that the resulting composition can exhibit a synergistic combination of excellent flame retardant properties, long-term heat aging stability, excellent mechanical properties including high strength, and can even include good electrical properties (i.e., low dielectric constant and dissipation factor).

In one aspect, the present disclosure is directed to a flame retardant polymer composition that contains at least one thermoplastic resin in combination with a flame retardant system. The flame retardant system can include a combination of a metal phosphinate and a synergist. The synergist can be, for instance, a melamine metal phosphate or a melamine poly(metal phosphate). Of particular advantage, the combination of the metal phosphinate and the synergist has been found to dramatically improve the flame resistant properties of the polymer composition at extremely small thicknesses without having to incorporate into the polymer composition a metal salt, such as zinc borate. For example, the polymer composition of the present disclosure can be formulated so as to exhibit a VO rating as determined in accordance with UL 94 at a thickness of only 1 mm, such as only 0.8 mm, such as only 0.4 mm. In addition, it was discovered that not only does the flame retardant system of the present disclosure not interfere with the melt processing characteristics of the polymer composition, but actually has been found to produce a polymer composition with better melt flow properties and processing characteristics than many flame retardant compositions formulated in the past. This result was completely unexpected.

The degree to which the composition can extinguish a fire (“char formation”) may be represented by its Limiting Oxygen Index (“LOI”), which is the volume percentage of oxygen needed to support combustion. More particularly, the LOI of the polymer composition may be about 25 or more, in some embodiments about 27 or more, in some embodiments about 28 or more, and in some embodiments, from about 30 to 100, as determined in accordance with ISO 4589:2017 (technically equivalent to ASTM D2863-19).

In one aspect, the polymer composition of the present disclosure can further contain a stabilizer package. The stabilizer package can include an antioxidant, a heat stabilizer, and optionally a light stabilizer. The stabilizer package in combination with the flame retardant system has been found to greatly improve the heat aging characteristics of the polyamide polymer composition in comparison to flame retardant formulations used in the past. For instance, even after being heat aged for 1,500 hours at 200° C., polymer compositions formulated in accordance with the present disclosure can exhibit a reduction in notched Charpy impact resistance strength of less than 50%, such as less than about 45%, such as less than about 40%, such as even less than about 35%. In addition to impact resistance strength, the tensile strength of the polymer composition also displays excellent heat aging properties. For example, after being heat aged at 200° C. for 1,500 hours, the tensile strength of the polymer composition may decrease by no more than about 50%, such as by no more than about 45%, such as by no more than about 40%, such as by no more than about 35%.

In addition to flame retardant properties and/or heat aging stability, the polymer composition of the present disclosure can also display excellent comparative tracking index properties. The comparative tracking index (CTI) is the maximum voltage, measured in volts, at which a material withstands 50 drops of contaminated water without tracking. Tracking is defined as the formation of conductive paths due to electrical stress, humidity, and contamination. The comparative tracking index test is an accelerated simulation to determine possible future failures that typically result in a short in electrical equipment using the polyamide polymer composition as an insulating material. Comparative tracking index can be measured according to Test IEC 60112:2020. The flame retardant polyamide polymer composition of the present disclosure can be formulated to display a comparative tracking index of 600 volts or more, such as 650 volts or more, such as 700 volts or more.

Due to the excellent flame resistance properties, excellent mechanical properties, and/or excellent thermal stability properties in combination with improved melt processing properties, the polymer composition of the present disclosure is well suited for making all different types of articles and components.

In one embodiment, a composite tape can be formed from the fiber-reinforced polymer composition. The tape can include a plurality of long reinforcing fibers that are continuous and unidirectionally oriented with in the polymer matrix. The fibers can be present in the tape in an amount of from about 50% to about 70% by weight. In one aspect, the tape can be over molded with a fiber-containing composition.

The polymer composition is particularly well suited for producing all different types of electrical components. Such articles can include high voltage powertrain components and other devices that may be powered using lithium ion batteries. The polymer composition can serve as a housing for encasing the electrical component or can be an insulative component that directly surrounds an electrical contact pin or other conductive member. The long fiber-reinforced polymer composition of the present disclosure can also be formulated with good electrical properties making the composition also well suited for producing a housing for an electronic module that receives one or more electronic components, such as a printed circuit board, antennae elements, radio frequency sensing elements, sensors, transmitting elements, cameras, global positioning devices, and the like. In still another embodiment, the polymer composition is used to produce a structural component of a battery, such as a side support, a cover, a separator, or a bottom support.

In addition to the above, the long fiber-reinforced polymer composition of the present disclosure can also be used in numerous other applications. For example, the polymer composition provides light weighting, better dimensional control, thinner walls, higher impact, higher temperature performance, and better creep and fatigue than many other similar compositions.

Various embodiments of the present invention will now be described in more detail.

### I. Polymer Matrix

A. Thermoplastic Polymer

The polymer matrix functions as a continuous phase of the composition and contains one or more thermoplastic polymers. Thermoplastic polymers well suited for use in the composition include polyamide polymers, polyarylene sulfide polymers, polyaryletherketone polymers, polyimide polymers, and mixtures thereof. The one or more thermoplastic polymers can be present in the polymer matrix in an amount from about 40% by weight to about 90% by weight, including all increments of 1% by weight therebetween. For example, one or more thermoplastic polymers can be contained in the polymer composition in an amount greater than about 45% by weight, such as in an amount greater than about 50% by weight, such as in an amount greater than about 55% by weight and generally in an amount less than about 85% by weight, such as in an amount less than about 80% by weight, such as in an amount less than about 75% by weight, such as in an amount less than about 70% by weight, such as in an amount less than about 65% by weight, such as in an amount less than about 60% by weight.

The long fiber-reinforced polymer composition of the present disclosure is particularly well suited for use with polyamide polymers.

Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed. When such a blend is employed, the weight ratio of nylon-66 to nylon-6 is typically from 1 to about 2, in some embodiments from about 1.1 to about 1.8, and in some embodiments, from about 1.2 to about 1.6.

It is also possible to include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene terephthalamide/dodecamethylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

In one embodiment, the polymer composition contains primarily aliphatic polyamide polymers that may be blended with one or more semi-aromatic polyamide polymers or a wholly aromatic polyamide polymer. In other embodiments, the polymer composition may only contain semi-aromatic polyamide polymers, may only contain wholly aromatic polyamide polymers, or may only contain a combination of semi-aromatic polyamide polymers and wholly aromatic polyamide polymers.

The polyamide employed in the polymer composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2013 (glass transition) and 11357-3:2011 (melting).

In one embodiment, the polyamide polymer incorporated into the polymer composition can comprise a post-industrial recycled polymer. For instance, the recycled polyamide polymer can be obtained from industrial fiber including tire cord, from carpet fiber, from textile fiber, from films, from fabrics including airbag fabrics, and the like. When incorporated into the polymer composition, the recycled polyamide polymers are optionally combined with virgin polymers. For example, the weight ratio between recycled polyamide polymers and virgin polyamide polymers can be from about 1:10 to about 10:1. For example, the amount of recycled polyamide polymer incorporated into the polymer composition can be greater than about 8% by weight, such as greater than about 10% by weight, such as greater than about 12% by weight, such as greater than about 15% by weight, such as greater than about 18% by weight, such as greater than about 20% by weight, such as greater than about 22% by weight, such as greater than about 30% by weight, such as greater than about 40% by weight, such as greater than about 50% by weight, such as greater than about 70% by weight, such as greater than about 80% by weight, such as greater than about 90% by weight, such as up to 100% by weight. The recycled polyamide is generally present in an amount less than about 90% by weight, such as in an amount less than about 70% by weight, such as in an amount less than about 50% by weight, such as in an amount less than about 45% by weight, such as less than about 35% by weight, such as less than about 30% by weight, based on the total amount of polyamide polymers present.

B. Flame Retardant System

In addition to one or more thermoplastic polymers, the polymer matrix may also contain a flame retardant system to help achieve the desired flammability performance. In one aspect, the flame retardant system of the present disclosure only contains two flame retardant components, although in other embodiments various other components may be added. Excellent flame resistant properties in combination with excellent melt processing characteristics can be obtained by only incorporating into the polymer composition a non-halogen flame retardant in combination with a synergist. Constructing the flame retardant system from only two components is believed to provide numerous benefits regarding various efficiencies in formulating the composition in combination with excellent overall properties.

In one embodiment, the flame retardant system of the present disclosure contains a metal phosphinate in combination with a synergist. The synergist can comprise an azine metal phosphate or an azine poly(metal phosphate).

The amount of flame retardant system incorporated into the polymer composition can vary depending upon the particular application and the desired result. In general, the flame retardant system is present in the polymer composition in an amount greater than about 16% by weight, such as in an amount greater than about 18% by weight. In one embodiment, the amount of flame retardant system incorporated into the polymer composition can be relatively high without any adverse impacts on the mechanical properties of the composition or on the ability to melt process the composition. For example, the flame retardant system can be incorporated into the polymer composition in an amount greater than about 12% by weight, such as in an amount of greater than about 15% by weight, such as in an amount greater than about 18.5% by weight, such as in an amount greater than about 19% by weight, such as in an amount greater than about 19.5% by weight, such as in an amount greater than about 20% by weight, such as in an amount greater than about 20.5% by weight, such as in an amount greater than about 21% by weight, such as in an amount greater than about 21.5% by weight, such as in an amount greater than about 22% by weight. The flame retardant system is generally present in the composition in an amount less than about 28% by weight, such as in an amount less than about 25% by weight, such as in an amount less than about 24% by weight.

As described above, the flame retardant system can include a phosphinate flame retardant, such as a metal phosphinate. Such phosphinates are typically salts of a phosphinic acid and/or diphosphinic acid, such as those having the general formula (I) and/or formula (11):

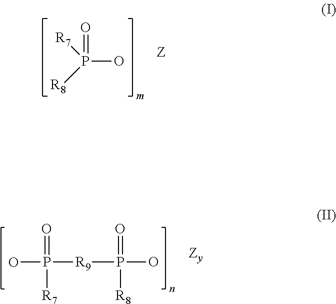

wherein,

R₇ and R₈ are, independently, hydrogen or substituted or unsubstituted, straight chain, branched, or cyclic hydrocarbon groups (e.g., alkyl, alkenyl, alkynyl, aralkyl, aryl, alkaryl, etc.) having 1 to 6 carbon atoms, particularly alkyl groups having 1 to 4 carbon atoms, such as methyl, ethyl, n-propyl, iso-propyl, n-butyl, or tert-butyl groups;

R₉ is a substituted or unsubstituted, straight chain, branched, or cyclic C₁-C₁₀ alkylene, arylene, arylalkylene, or alkylarylene group, such as a methylene, ethylene, n-propylene, iso-propylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, t-butylnaphthylene, phenylethylene, phenylpropylene or phenylbutylene group;

Z is Mg, Ca, Al, Sb, Sn, Ge, Ti, Zn, Fe, Zr, Ce, Bi, Sr, Mn, Li, Na, K, and/or a protonated nitrogen base;

y is from 1 to 4, and preferably 1 to 2 (e.g., 1);

n is from 1 to 4, and preferably 1 to 2 (e.g. 1); and

m is from 1 to 4 and preferably 1 to 2 (e.g., 2).

The phosphinates may be prepared using any known technique, such as by reacting a phosphinic acid with a metal carbonate, metal hydroxide, or metal oxides in aqueous solution. Particularly suitable phosphinates include, for example, metal salts of dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid, hypophosphoric acid, etc. The resulting salts are typically monomeric compounds; however, polymeric phosphinates may also be formed. Particularly suitable metals for the salts may include Al and Zn. For instance, one particularly suitable phosphinate is zinc diethylphosphinate. Another particularly suitable phosphinate is aluminum diethylphosphinate.

One or more metal phosphinates can generally be present in the polymer composition in an amount greater than about 8% by weight, such as in an amount greater than about 10.5% by weight, such as in an amount greater than about 12.5% by weight, such as in an amount greater than about 13% by weight, such as in an amount greater than about 13.5% by weight, such as in an amount greater than about 14% by weight. One or more metal phosphinates are generally present in the polymer composition in an amount less than about 20% by weight, such as in an amount less than about 18% by weight, such as in an amount less than about 16% by weight.

In accordance with the present disclosure, the metal phosphinate is combined with a synergist. The synergist can comprise an azine metal phosphate or an azine poly(metal phosphate). In one aspect, the synergist can comprise a triazine-intercalated metal phosphate or poly(metal phosphate). The synergist, for instance, can be formed by the reaction of an acidic metal phosphate with melamine. Examples of synergists that are particularly well suited for use in the present disclosure include melamine zinc phosphate, melamine poly(zinc phosphate), melamine magnesium phosphate, melamine poly(magnesium phosphate), melamine calcium phosphate, melamine poly(calcium phosphate) or mixtures thereof.

In one aspect, the synergist can be (melamine)₂Mg(HPO₄)₂, (melamine)₂Ca(HPO₄)₂, (melamine)₂Zn(HPO₄)₂, (melamine)₃Al(HPO₄)₃, (melamine)₂Mg(P₂O₇), (melamine)₂Ca(P₂O₇), (melamine)₂Zn(P₂O₇), (melamine)₃Al(P₂O₇)_{3/2}.

In one aspect, the synergist can be melamine poly(metal phosphates) that are known as hydrogenphosphato- or pyrophosphatometalates with complex anions having a tetra- or hexavalent metal atom as coordination site with bidentate hydrogenphosphate or pyrophosphate ligands.

In one aspect, the synergist can be melamine-intercalated aluminum, zinc or magnesium salts of condensed phosphates, very particular preference to bismelamine zincodiphosphate and/or bismelamine aluminotriphosphate.

In one aspect, the synergist can be aluminum phosphates, aluminum monophosphates, aluminum orthophosphates (AlPO.sub.4), aluminum hydrogenphosphate (Al₂(HPO₄)₃) and/or aluminum dihydrogenphosphate.

In one aspect, the synergist can be calcium phosphate, zinc phosphate, titanium phosphate and/or iron phosphate.

In one aspect, the synergist can be calcium hydrogenphosphate, calcium hydrogenphosphate dihydrate, magnesium hydrogenphosphate, titanium hydrogenphosphate (TIHC) and/or zinc hydrogenphosphate.

In one aspect, the synergist can be aluminum dihydrogenphosphate, magnesium dihydrogenphosphate, calcium dihydrogenphosphate, zinc dihydrogenphosphate, zinc dihydrogenphosphate dihydrate and/or aluminum dihydrogenphosphate.

In one aspect, the synergist can be calcium pyrophosphate, calcium dihydrogenpyrophosphate, magnesium pyrophosphate, zinc pyrophosphate and/or aluminum pyrophosphate.

The synergist can generally be present in the polymer composition in an amount greater than about 4% by weight, such as in an amount greater than about 5% by weight, such as in an amount greater than about 6.5% by weight, such as in an amount greater than about 7% by weight, and generally less than about 12% by weight, such as in an amount less than about 9% by weight, such as in an amount less than about 8% by weight.

As described above, in one embodiment, the flame retardant system can be comprised of only the two components described above. It was discovered that excellent flame retardancy characteristics can be obtained without having to add other components that were conventionally used in the past. For instance, the polymer composition can be formulated so as to be free of metal oxides, metal hydroxides, borates, silicates, stannates, or the like that have been used in the past to increase flame retardant properties. For example, the polymer composition can be free of magnesium oxide, zinc oxide, manganese oxide, tin oxide, dihydrotalcite, hydrocalumite, magnesium hydroxide, calcium hydroxide, zinc hydroxide, tin oxide hydrate, manganese hydroxide, zinc borate, basic zinc silicate, zinc stannate, and the like.

The polymer composition can also be free of halogen-based flame retardants. Further, conventional nitrogen synergists can also be excluded from the composition. For example, the composition can be free of melamine polyphosphate and/or melamine cyanurate.

C. Stabilizer Packaqe

In one aspect, the polymer composition can further contain a stabilizer package. The stabilizer package has been found to dramatically improve the thermal aging stability of the composition. The stabilizer package can include, for instance, an antioxidant, a heat stabilizer, and optionally a light stabilizer.

The antioxidant, for instance, can be a phenolic antioxidant. In one embodiment, for instance, the composition can contain a phenolic antioxidant. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-,dioctadecyl ester (Irganox® 1093); 1,3,5-trimethyl-2,4,6-tris(3′,5′-di-tert-butyl-4′ hydroxybenzyl)benzene (Irganox® 1330): 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® CS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol](Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and the like.

In one embodiment, the antioxidant can be a reaction product of 2,4-di-tert-butylphenol, phosphorous trichloride, and 1,1′-biphenyl.

One or more antioxidants can be present in the polymer composition generally in an amount greater than about 0.05% by weight, such as in an amount greater than about 0.08% by weight, such as in an amount greater than about 0.1% by weight, such as in an amount greater than about 0.15% by weight, such as in an amount greater than about 0.18% by weight, and generally less than about 2% by weight, such as less than about 1.5% by weight, such as less than about 1% by weight, such as less than about 0.8% by weight, such as less than about 0.5% by weight, such as less than about 0.4% by weight.

The heat stabilizer contained in the stabilizer package can comprise a copper complex. It is believed that the combination of the copper complex and the antioxidant greatly increase the thermal stability characteristics of the composition. In one embodiment, for instance, the heat stabilizer can comprise iodobis(triphenylphosphino) copper.

In general, the heat stabilizer can include a copper compound that can include a copper(I) salt, copper(II) salt, copper complex, or a combination thereof. For example, the copper(I) salt may be CuI, CuBr, CuCl, CuCN, CU₂O, or a combination thereof and/or the copper(II) salt may be copper acetate, copper stearate, copper sulfate, copper propionate, copper butyrate, copper lactate, copper benzoate, copper nitrate, CuO, CuCl₂, or a combination thereof. In certain embodiments, the copper compound may be a copper complex that contains an organic ligand, such as alkyl phosphines, such as trialkylphosphines (e.g., tris-(n-butyl)phosphine) and/or dialkylphosphines (e.g., 2-bis-(dimethylphosphino)-ethane); aromatic phosphines, such as triarylphosphines (e.g., triphenylphosphine or substituted triphenylphosphine) and/or diarylphosphines (e.g., 1,6-(bis-(diphenylphosphino))-hexane, 1,5-bis-(diphenylphosphino)-pentane, bis-(diphenylphosphino)methane, 1,2-bis-(diphenylphosphino)ethane, 1,3-bis-(diphenylphosphino)propane, 1,4-bis-(diphenylphosphino)butane, etc.); mercaptobenzimidazoles; glycines; oxalates; pyridines (e.g., bypyridines); amines (e.g., ethylenediaminetetraacetates, diethylenetriamines, triethylenetetramines, etc.); acetylacetonates; and so forth, as well as combinations of the foregoing. Particularly suitable copper complexes for use in the heat stabilizer may include, for instance, copper acetylacetonate, copper oxalate, copper EDTA, [Cu(PPh₃)₃X], [Cu₂X(PPH₃)₃], [Cu(PPh₃)X], [Cu(PPh₃)₂X], [CuX(PPh₃)-2,2′-bypyridine], [CuX(PPh₃)-2,2′-biquinoline)], or a combination thereof, wherein PPh₃ is triphenylphosphine and X is Cl, Br, I, CN, SCN, or 2-mercaptobenzimidazole. Other suitable complexes may likewise include 1,10-phenanthroline, o-phenylenebis(dimethylarsine), 1,2-bis(diphenylphosphino)-ethane, terpyridyl, and so forth.

When employed, the copper complexes may be formed by reaction of copper ions (e.g., copper(I) ions) with the organic ligand compound (e.g., triphenylphosphine or mercaptobenzimidazole compounds). For example, these complexes can be obtained by reacting triphenylphosphine with a copper(I) halide suspended in chloroform (G. Kosta, E. Reisenhofer and L. Stafani, J. Inorg. Nukl. Chem. 27 (1965) 2581). However, it is also possible to reductively react copper(II) compounds with triphenylphosphine to obtain the copper(I) addition compounds (F. U. Jardine, L. Rule, A. G. Vohrei, J. Chem. Soc. (A) 238-241 (1970)). However, the complexes used according to the invention can also be produced by any other suitable process. Suitable copper compounds for the preparation of these complexes are the copper(I) or copper(II) salts of the hydrogen halide acids, the hydrocyanic acid or the copper salts of the aliphatic carboxylic acids. Examples of suitable copper salts are copper (I) chloride, copper (I) bromide, copper (I) iodide, copper (I) cyanide, copper (II) chloride, copper (II) acetate, copper (II) stearate, etc., as well as combinations thereof. Copper(I)iodide and copper(I)cyanide are particularly suitable.

In addition to a copper compound, the heat stabilizer may also contain a halogen-containing synergist. When employed, the copper compound and halogen-containing synergist are typically used in quantities to provide a copper:halogen molar ratio of from about 1:1 to about 1:50, in some embodiments from about 1:4 to about 1:20, and in some embodiments, from about 1:6 to about 1:15. For example, the halogen content of the polymer composition may be from about 1 ppm to about 10,000 ppm, in some embodiments from about 50 ppm to about 5,000 ppm, in some embodiments from about 100 ppm to about 2,000 ppm, and in some embodiments, from about 300 ppm to about 1,500 ppm. In one aspect, the halogen content of the polymer composition is less than about 1000 ppm, such as less than about 600 ppm, such as less than about 500 ppm, such as less than about 400 ppm.

The halogenated synergist generally includes an organic halogen-containing compound, such as aromatic and/or aliphatic halogen-containing phosphates, aromatic and/or aliphatic halogen-containing hydrocarbons; and so forth, as well as combinations thereof. For example, suitable halogen-containing aliphatic phosphates may include tris(halohydrocarbyl)-phosphates and/or phosphonate esters. Tris(bromohydrocarbyl) phosphates (brominated aliphatic phosphates) are particularly suitable. In particular, in these compounds, no hydrogen atoms are attached to an alkyl C atom which is in the alpha position to a C atom attached to a halogen. This minimizes the extent that a dehydrohalogenation reaction can occur which further enhances stability of the polymer composition. Specific exemplary compounds are tris(3-bromo-2,2-bis(bromomethyl)propyl)phosphate, tris(dibromoneopentyl)phosphate, tris(trichloroneopentyl)phosphate, tris(bromodichlorneopentyl)phosphate, tris(chlordibromoneopentyl)phosphate, tris(tribromoneopentyl)phosphate, or a combination thereof. Suitable halogen-containing aromatic hydrocarbons may include halogenated aromatic polymers (including oligomers), such as brominated styrene polymers (e.g., polydibromostyrene, polytribromostyrene, etc.); halogenated aromatic monomers, such as brominated phenols (e.g., tetrabromobisphenol-A); and so forth, as well as combinations thereof.

The heat stabilizer can be present in the polymer composition generally in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, and generally in an amount less than about 2.5% by weight, such as in an amount less than about 2% by weight, such as in an amount less than about 1.5% by weight, such as in an amount less than about 1% by weight, such as in an amount less than about 0.8% by weight. In one aspect, The resulting copper content of the polymer composition can be from about 1 ppm to about 1,000 ppm, in some embodiments from about 3 ppm to about 200 ppm, in some embodiments from about 5 ppm to about 150 ppm, and in some embodiments, from about 20 ppm to about 120 ppm.

As described above, the stabilizer package can optionally include a light stabilizer which may comprise a hindered amine light stabilizer. Examples of light stabilizers that may be incorporated into the present disclosure include a benzendicarboxamide. The light stabilizer may also comprise any compound which is derived from an alkylsubtituted piperidyl, piperidinyl or piperazinone compound or a substituted alkoxypiperidinyl. Other suitable HALS are those that are derivatives of 2,2,6,6-tetramethyl piperidine. Preferred specific examples of HALS include: ˜2,2,6,6-tetramethyl-4-piperidinone, ˜2,2,6,6-tetramethyl-4-piperidinol, ˜bis-(2,2,6,6-tetramethyl-4-piperidinyl)-sebacate, ˜mixtures of esters of 2,2,6,6-tetramethyl-4-piperidinol and fatty acids, ˜bis-(2,2,6,6-tetramethyl-4-piperidinyl)-succinate, ˜bis-(1-octyloxy-2,2,6,6-tetramethyl-4-piperidinyl)-sebacate, ˜bis-(1,2,2,6,6-pentamethyl-4-piperidinyl)-sebacate, ˜tetrakis-(2,2,6,6-tetramethyl-4-piperidyl)-1,2,3,4-butane-tetracarboxylate, ˜N-butyl-2,2,6,6-tetramethyl-4-piperidinamine, ˜N,N′-bis-(2,2,6,6-tetramethyl-4-piperidyl)-hexane-1,6-diamine, ˜2.2′-[(2.2.6.6-tetramethyl-4-piperidinyl)-imino]-bis-[ethanol], ˜5-(2.2.6.6-tetramethyl-4-piperidinyl)-2-cyclo-undecyl-oxazole), ˜mixture of: 2,2,4,4 tetramethyl-21-oxo-7-oxa-3.20-diazadispiro [5.1.11.2] heneicosane-20-propionic acid dodecylester and 2.2.4.4 tetramethyl-21-oxo-7; oxa-3,20-diazadispiro [5,1,11,2]-heneicosane-20-propionic acid; tetradecyl ester, ˜diacetam 5 (CAS registration number: 76505-58-3), ˜propanedioic acid, [(4-methoxyphenyl) methylene]-, bis(1,2,2,6,6-pentamethyl-4-piperidinyl) ester, ˜1,3-benzendicarboxamide, N,N′-bis (2,2,6,6-tetramethyl-4-piperidinyl), ˜3-dodecyl-1-(2,2,6,6-tetramethyl-4-piperidyl)-pyrrolidin-2,5-dione, ˜formamide, N,N′-1,6-hexanediylbis [N-(2,2,6,6-tetramethyl-4-piperidinyl, ˜3-dodecyl-1-(1,2,2,6,6-pentamethyl-4-piperidyl)-pyrrolidin-2,5-dione, ˜1,5-Dioxaspiro (5,5) undecane 3,3-dicarboxylic acid, bis (2,2,6,6-tetramethyl-4-peridinyl) ester, ˜1,5-Dioxaspiro (5,5) undecane 3,3-dicarboxylic acid, bis (1,2,2,6,6-pentamethyl-4-peridinyl) ester, ˜bis (1,2,2,6,6-penta methyl-4-piperidyl)(3,5-di-t-butyl-4-hydroxybenzyl)-butylpropanedioate, ˜tetrakis-(1,2,2,6,6-penta-methyl-4-piperidyl)-1,2,3,4-butane-tetra-carboxylate, ˜1,2,3,4-butanetetracarboxylic acid, tetrakis(2,2,6,6-tetramethyl-4-piperidinyl) ester, ˜1,2,3,4-butane-tetracarboxylic acid-1,2,3-tris (1,2,2,6,6-pentamethyl-4-piperidinyl)-4-tridecylester, ˜8-acetyl-3-dodecyl-7,7,9,9-tetra methyl-1,3,8-triazaspiro (4,5) decane-2,4-dione, ˜N-2,2,6,6-tetrametyl-4-piperidinyl-N-amino-oxamide, ˜4-acryloyloxy-1,2,2,6,6-pentamethyl-4-piperidine, ˜1,5,8,12-tetrakis [2′,4′-bis (1″,2″,2″,6″,6″-pentamethyl-4″-piperidinyl(butyl)amino)-1′,3′,5′-tr-iazin-6′-yl]-1,5,8,12-tetraazadodecane, ˜1,1′-(1,2-ethane-di-yl)-bis-(3,3′, 5,5′-tetra-methyl-piperazinone) (Good rite 3034), ˜propane amide, 2-methyl-N-(2,2,6,6-tetramethyl-4-piperidinyl)-2-[(2,2,6,6-tetramethyl-4-piperidinyl)amino], ˜oligomer of N-(2-hydroxyethyl)-2,2,6,6-tetramethyl-4-piperidinol and succinic acid, ˜poly [[6-[(1,1,3,3-tetramethylbutyl)amino]-s-triazine-2,4-diyl][2,2,6,6-tetram-ethyl-4-piperidinyl)imino] hexamethylene [(2,2,6,6-tetramethyl-4-piperidinyl)imino]], ˜poly [(6-morfoline-S-triazine-2.4-diyl) [(2.2.6.6-tetramethyl-4-piperidinyl)-imino]hexamethylene-[(2.2.6.6-tetram-ethyl-4-piperidinyl)-imino]], ˜ poly [(6-morpholino-s-triazine-2.4-diyl) [1.2.2.6.6-penta-methyl-4-piperidyl) imino]-hexamethylene [(2,2,6,6 tetra-methyl-4-piperidyl) imino]], ˜poly methylpropyl-3-oxy-[4(2.2.6.6-tetrametyl)-piperidinyl)]-siloxane copolymer of a-methylstyrene and n-(2.2.6.6-tetramethyl-piperidinyl)-4-maleimide and N-stearyl-maleimide, ˜1,2,3,4-butane tetracarboxylic acid, polymer with 8,8,8′,8′-tetramethyl-2,4,8,10-tetraoxaspiro [5,5] undecane-3,9-diethanol, 1,2,2,6,6-pentamethyl-4-piperidinyl ester, ˜1,2,3,4-butanetetracarboxylic acid, polymer with 8,8,8′,8′-tetramethyl-2,4,8,10-tetraoxaspiro [5,5] undecane-3,9-diethanol, 2,2,6,6-tetramethyl-4-piperidinyl ester, ˜oligomer of 7-Oxa-3,20-diazadispiro [5,1,11,2] heneicosan-21-one, 2,2,4,4-tetramethyl-20-(oxiranylmethyl), ˜1,3,5-Triazine-2,4,6-triamine, N, N″-[1,2-ethanediylbis [[[4,6-bis[butyl(1,2,2,6,6-pentamethyl-4-iperidinyl)amino]-1,3,5-triazine-2-yl]imino]-3,1-propanediyl]]-bis [N. N″-dibutyl-N. N″-bis (1.2.2.6.6-pentamethyl-4-piperidinyl), ˜1.3-Propanediamine, N, N-1,2-ethanediylbis-, polymer with 2,4,6-trichloro-1,3,5-triazine, reaction products with N-butyl-2,2,6,6-tetramethyl-4-piperidinamine, ˜1.6-Hexanediamine, N,N′-bis (2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine, ˜2,9,11,13,15,22,24,26,27,28-Decaazatricyclo [21,3,1,110,14]octacosa-1(27), 10,12,14(28),23,25-hexaene-12,25-diamine, N,N′-bis (1,1,3,3-tetramethylbutyl)-2,9,15,22-tetrakis (2,2,6,6-tetramethyl-4-piperidinyl)-, ˜1,1,1″-(1,3,5-Triazine-2,4,6-triyltris ((cyclohexylimino)-2,1-ethanediyl) tris (3,3,5,5-tetramethylpiperazinone), 1,1,1″-(1,3,5-Triazine-2,4,6-triyltris((cyclohexylimino)-2,1-ethylenediyl) tris (3,3,4,5,5-tetramethylpiperazinone), ˜1,6-hexanediamine, N, N′-bis (2,2,6,6-tetramethyl-4-piperidinyl)-, polymer with 2,4,6-trichloro-1,3,5-triazine, reaction products with 3-bromo-1-propene, nbutyl-1-butanamine and N-butyl-2,2,6,6-tetramethyl-4-piperidinamine, oxidised, hydrogenated, ˜Alkenes, (C₂₀-24)-4 alpha-, polymers with maleic anhydride, reaction products with 2,2,6,6-tetramethyl-4-piperidinamine, ˜N-2,2,6,6-tetramethyl-4-piperidinyl-N-amino-oxamide; 4-acryloyloxy-1,2,2,6,6-pentamethyl-4-piperidine; HALS PB-41 or mixtures thereof.

One or more light stabilizers can generally be present in the composition in an amount greater than about 0.01% by weight, such as in an amount greater than about 0.05% by weight, such as in an amount greater than about 0.08% by weight, and generally in an amount less than about 2% by weight, such as in an amount less than about 1% by weight, such as in an amount less than about 0.8% by weight, such as in an amount less than about 0.5% by weight, such as in an amount less than about 0.3% by weight, such as in an amount less than about 0.2% by weight.

D. Other Components

In addition to the components noted above, the polymer matrix may also contain a variety of other components. Examples of such optional components may include, for instance, EMI fillers, compatibilizers, particulate fillers, lubricants, colorants, flow modifiers, pigments, and other materials added to enhance properties and processability. When EMI shielding properties are desired, for instance, an EMI filler may be employed. The EMI filler is generally formed from an electrically conductive material that can provide the desired degree of electromagnetic interference shielding. In certain embodiments, for instance, the material contains a metal, such as stainless steel, aluminum, zinc, iron, copper, silver, nickel, gold, chrome, etc., as well alloys or mixtures thereof. The EMI filler may also possess a variety of different forms, such as particles (e.g., iron powder), flakes (e.g., aluminum flakes, stainless steel flakes, etc.), or fibers. Particularly suitable EMI fillers are fibers that contain a metal. In such embodiments, the fibers may be formed from primarily from the metal (e.g., stainless steel fibers) or the fibers may be formed from a core material that is coated with the metal. When employing a metal coating, the core material may be formed from a material that is either conductive or insulative in nature. For example, the core material may be formed from carbon, glass, or a polymer. One example of such a fiber is nickel-coated carbon fibers.

In one aspect, a lubricant can be present in the polymer composition. Any suitable lubricant can be incorporated into the polymer composition. In one aspect, the lubricant can comprise a partially saponified ester wax. For example, the lubricant can comprise a partially saponified ester wax of a C22 to C36 fatty acid. The fatty acid, for instance, can comprise a montan wax. In one aspect, the lubricant can contain 1-methyl-1,3-propanediyl esters. The lubricant can be present in the polymer composition generally in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, and generally in an amount less than about 2.5% by weight, such as in an amount less than about 2% by weight, such as in an amount less than about 1.5% by weight, such as in an amount less than about 1% by weight, such as in an amount less than about 0.8% by weight.

A compatibilizer may also be employed to enhance the degree of adhesion between the long fibers with the polymer matrix. When employed, such compatibilizers typically constitute from about 0.1 wt. % to about 15 wt. %, in some embodiments from about 0.5 wt. % to about 10 wt. %, and in some embodiments, from about 1 wt. % to about 5 wt. % of the polymer composition. In certain embodiments, the compatibilizer may be a polyolefin compatibilizer that contains a polyolefin that is modified with a polar functional group. The polyolefin may be an olefin homopolymer (e.g., polypropylene) or copolymer (e.g., ethylene copolymer, propylene copolymer, etc.). The functional group may be grafted onto the polyolefin backbone or incorporated as a monomeric constituent of the polymer (e.g., block or random copolymers), etc. Particularly suitable functional groups include maleic anhydride, maleic acid, fumaric acid, maleimide, maleic acid hydrazide, a reaction product of maleic anhydride and diamine, dichloromaleic anhydride, maleic acid amide, etc.

Regardless of the particular components employed, the raw materials (e.g., thermoplastic polymers, flame retardants, stabilizers, compatibilizers, etc.) are typically melt blended together to form the polymer matrix prior to being reinforced with the long fibers. The raw materials may be supplied either simultaneously or in sequence to a melt-blending device that dispersively blends the materials. Batch and/or continuous melt blending techniques may be employed. For example, a mixer/kneader, Banbury mixer, Farrel continuous mixer, single-screw extruder, twin-screw extruder, roll mill, etc., may be utilized to blend the materials. One particularly suitable melt-blending device is a co-rotating, twin-screw extruder (e.g., ZSK-30 twin-screw extruder available from Werner & Pfleiderer Corporation of Ramsey, N.J.). Such extruders may include feeding and venting ports and provide high intensity distributive and dispersive mixing. For example, the thermoplastic polymer may be fed to a feeding port of the twin-screw extruder and melted. Thereafter, the stabilizers may be injected into the polymer melt. Alternatively, the stabilizers may be separately fed into the extruder at a different point along its length. Regardless of the particular melt blending technique chosen, the raw materials are blended under high shear/pressure and heat to ensure sufficient mixing. For example, melt blending may occur at a temperature of from about 150° C. to about 300° C., in some embodiments, from about 155° C. to about 250° C., and in some embodiments, from about 160° C. to about 220° C.

### II. Lonq Fibers

To form the fiber-reinforced composition of the present invention, long fibers are generally embedded within the polymer matrix. Long fibers may, for example, constitute from about 10 wt. % to about 70 wt. %, in some embodiments from about 12 wt. % to about 38 wt. %, and in some embodiments, from about 15 wt. % to about 35 wt. % of the composition. When continuous fibers are used to produce tapes, the fibers can comprise from about 50% by weight to about 70% by weight of the composite. The polymer matrix typically constitutes from about 30 wt. % to about 90 wt. %, in some embodiments from about 45 wt. % to about 70 wt. %, and in some embodiments, from about 50 wt. % to about 65 wt. % of the composition.

The term “long fibers” generally refers to fibers, filaments, yarns, or rovings (e.g., bundles of fibers) that can be continuous or have a length of from about 1 to about 25 millimeters, in some embodiments, from about 1.5 to about 20 millimeters, in some embodiments from about 2 to about 15 millimeters, and in some embodiments, from about 3 to about 12 millimeters. A substantial portion of the fibers may maintain a relatively large length even after being formed into a shaped part (e.g., injection molding). That is, the median length (D50) of the fibers in the composition may be about 1 millimeter or more, in some embodiments about 1.5 millimeters or more, in some embodiments about 2.0 millimeters or more, and in some embodiments, from about 2.5 to about 8 millimeters. Regardless of their length, the nominal diameter of the fibers (e.g., diameter of fibers within a roving) may be selectively controlled to help improve the surface appearance of the resulting polymer composition. More particularly, the nominal diameter of the fibers may range from about 20 to about 40 micrometers, in some embodiments from about 20 to about 30 micrometers, and in some embodiments, from about 21 to about 26 micrometers. Within this range, the tendency of the fibers to become “clumped” on the surface of a shaped part is reduced, which allows the color and the surface appearance of the part to predominantly stem from the polymer matrix. In addition to providing improved aesthetic consistency, it also allows the color to be better maintained after exposure to ultraviolet light as a stabilizer system can be more readily employed within the polymer matrix. Of course, it should be understood that other nominal diameters may be employed, such as those from about 1 to about 20 micrometers, in some embodiments from about 8 to about 19 micrometers, and in some embodiments, from about 10 to about 18 micrometers.

The fibers may be formed from any conventional material known in the art, such as metal fibers; glass fibers (e.g., E-glass, A-glass, C-glass, D-glass, AR-glass, R-glass, S1-glass, S2-glass), carbon fibers (e.g., graphite), boron fibers, ceramic fibers (e.g., alumina or silica), aramid fibers (e.g., Kevlar®), synthetic organic fibers (e.g., polyamide, polyethylene, paraphenylene, terephthalamide, polyethylene terephthalate and polyphenylene sulfide), metal fibers as described above (e.g., stainless fibers), and various other natural or synthetic inorganic or organic fibrous materials known for reinforcing thermoplastic compositions. Glass fibers, and particularly S-glass fibers, are particularly desirable. The fibers may be twisted or straight. If desired, the fibers may be in the form of rovings (e.g., bundle of fibers) that contain a single fiber type or different types of fibers. Different fibers may be contained in individual rovings or, alternatively, each roving may contain a different fiber type. For example, in one embodiment, certain rovings may contain carbon fibers, while other rovings may contain glass fibers. The number of fibers contained in each roving can be constant or vary from roving to roving. Typically, a roving may contain from about 1,000 fibers to about 50,000 individual fibers, and in some embodiments, from about 2,000 to about 40,000 fibers.

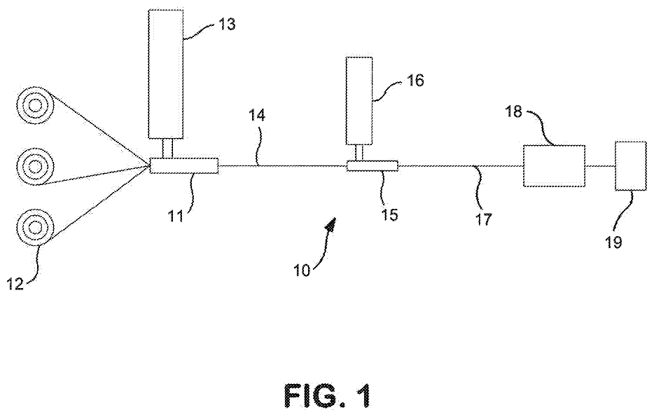

Any of a variety of different techniques may generally be employed to incorporate the fibers into the polymer matrix. The long fibers may be randomly distributed within the polymer matrix, or alternatively distributed in an aligned fashion. In one embodiment, for instance, continuous fibers may initially be impregnated into the polymer matrix to form strands, which are thereafter cooled and then chopped into pellets to that the resulting fibers have the desired length for the long fibers. In such embodiments, the polymer matrix and continuous fibers (e.g., rovings) are typically pultruded through an impregnation die to achieve the desired contact between the fibers and the polymer. Pultrusion can also help ensure that the fibers are spaced apart and aligned in the same or a substantially similar direction, such as a longitudinal direction that is parallel to a major axis of the pellet (e.g., length), which further enhances the mechanical properties. Referring to FIG. 1, for instance, one embodiment of a pultrusion process 10 is shown in which a polymer matrix is supplied from an extruder 13 to an impregnation die 11 while continuous fibers 12 are a pulled through the die 11 via a puller device 18 to produce a composite structure 14. Typical puller devices may include, for example, caterpillar pullers and reciprocating pullers. While optional, the composite structure 14 may also be pulled through a coating die 15 that is attached to an extruder 16 through which a coating resin is applied to form a coated structure 17. As shown in FIG. 1, the coated structure 17 is then pulled through the puller assembly 18 and supplied to a pelletizer 19 that cuts the structure 17 into the desired size for forming the long fiber-reinforced composition.

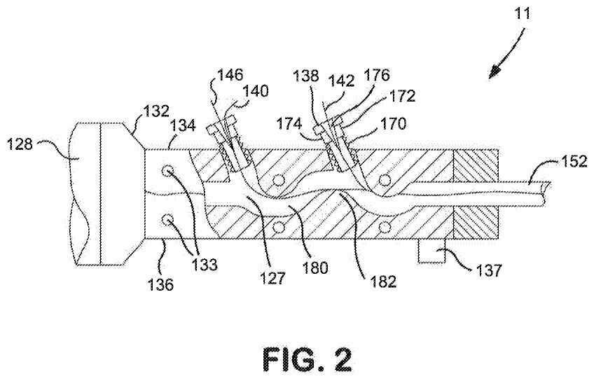

The nature of the impregnation die employed during the pultrusion process may be selectively varied to help achieved good contact between the polymer matrix and the long fibers. Examples of suitable impregnation die systems are described in detail in Reissue Patent No. 32,772 to Hawley; U.S. Pat. No. 9,233,486 to Reqan, et al.; and 9,278,472 to Eastep, et al. Referring to FIG. 2, for instance, one embodiment of such a suitable impregnation die 11 is shown. As shown, a polymer matrix 127 may be supplied to the impregnation die 11 via an extruder (not shown). More particularly, the polymer matrix 127 may exit the extruder through a barrel flange 128 and enter a die flange 132 of the die 11. The die 11 contains an upper die half 134 that mates with a lower die half 136. Continuous fibers 142 (e.g., roving) are supplied from a reel 144 through feed port 138 to the upper die half 134 of the die 11. Similarly, continuous fibers 146 are also supplied from a reel 148 through a feed port 140. The matrix 127 is heated inside die halves 134 and 136 by heaters 133 mounted in the upper die half 134 and/or lower die half 136. The die is generally operated at temperatures that are sufficient to cause melting and impregnation of the thermoplastic polymer. Typically, the operation temperature of the die is higher than the melt temperature of the polymer matrix. When processed in this manner, the continuous fibers 142 and 146 become embedded in the matrix 127. The mixture is then pulled through the impregnation die 11 to create a fiber-reinforced composition 152. If desired, a pressure sensor 137 may also sense the pressure near the impregnation die 11 to allow control to be exerted over the rate of extrusion by controlling the rotational speed of the screw shaft, or the federate of the feeder.

Within the impregnation die, it is generally desired that the fibers contact a series of impingement zones. At these zones, the polymer melt may flow transversely through the fibers to create shear and pressure, which significantly enhances the degree of impregnation. This is particularly useful when forming a composite from ribbons of a high fiber content. Typically, the die will contain at least 2, in some embodiments at least 3, and in some embodiments, from 4 to 50 impingement zones per roving to create a sufficient degree of shear and pressure. Although their particular form may vary, the impingement zones typically possess a curved surface, such as a curved lobe, rod, etc. The impingement zones are also typically made of a metal material.

FIG. 2 shows an enlarged schematic view of a portion of the impregnation die 11 containing multiple impingement zones in the form of lobes 182. It should be understood that this invention can be practiced using a plurality of feed ports, which may optionally be coaxial with the machine direction. The number of feed ports used may vary with the number of fibers to be treated in the die at one time and the feed ports may be mounted in the upper die half 134 or the lower die half 136. The feed port 138 includes a sleeve 170 mounted in upper die half 134. The feed port 138 is slidably mounted in a sleeve 170. The feed port 138 is split into at least two pieces, shown as pieces 172 and 174. The feed port 138 has a bore 176 passing longitudinally therethrough. The bore 176 may be shaped as a right cylindrical cone opening away from the upper die half 134. The fibers 142 pass through the bore 176 and enter a passage 180 between the upper die half 134 and lower die half 136. A series of lobes 182 are also formed in the upper die half 134 and lower die half 136 such that the passage 210 takes a convoluted route. The lobes 182 cause the fibers 142 and 146 to pass over at least one lobe so that the polymer matrix inside the passage 180 thoroughly contacts each of the fibers. In this manner, thorough contact between the molten polymer and the fibers 142 and 146 is assured.

To further facilitate impregnation, the fibers may also be kept under tension while present within the impregnation die. The tension may, for example, range from about 5 to about 300 Newtons, in some embodiments from about 50 to about 250 Newtons, and in some embodiments, from about 100 to about 200 Newtons per tow of fibers. Furthermore, the fibers may also pass impingement zones in a tortuous path to enhance shear. For example, in the embodiment shown in FIG. 2, the fibers traverse over the impingement zones in a sinusoidal-type pathway. The angle at which the rovings traverse from one impingement zone to another is generally high enough to enhance shear, but not so high to cause excessive forces that will break the fibers. Thus, for example, the angle may range from about 1° to about 30°, and in some embodiments, from about 5° to about 25°.

The impregnation die shown and described above is but one of various possible configurations that may be employed in the present invention. In alternative embodiments, for example, the fibers may be introduced into a crosshead die that is positioned at an angle relative to the direction of flow of the polymer melt. As the fibers move through the crosshead die and reach the point where the polymer exits from an extruder barrel, the polymer is forced into contact with the fibers. It should also be understood that any other extruder design may also be employed, such as a twin screw extruder. Still further, other components may also be optionally employed to assist in the impregnation of the fibers. For example, a “gas jet” assembly may be employed in certain embodiments to help uniformly spread a bundle or tow of individual fibers, which may each contain up to as many as 24,000 fibers, across the entire width of the merged tow. This helps achieve uniform distribution of strength properties in the ribbon. Such an assembly may include a supply of compressed air or another gas that impinges in a generally perpendicular fashion on the moving fiber tows that pass across the exit ports. The spread fiber bundles may then be introduced into a die for impregnation, such as described above.

The fiber-reinforced polymer composition may generally be employed to form a shaped part using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the fiber-reinforced composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the fiber-reinforced composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity. Due to the unique properties of the fiber-reinforced composition, relatively thin shaped parts (e.g., injection molded parts) can be readily formed therefrom. For example, such parts may have a thickness of about 10 millimeters or less, in some embodiments about 8 millimeters or less, in some embodiments about 6 millimeters or less, in some embodiments from about 0.4 to about 5 millimeters, and in some embodiments, from about 0.8 to about 4 millimeters (e.g., 0.8, 1.2. or 3 millimeters).

### II. Applications

Due to its unique properties, the fiber-reinforced polymer composition of the present disclosure can be used in all different types of applications. For instance, the fiber-reinforced polymer composition displays excellent flame retardant properties with improved processing. In one aspect, the composition can also display excellent thermal stability. Articles made from the polymer composition have excellent mechanical strength. The polymer composition can produce articles at relatively low weights while having excellent dimensional control. Articles formed with the polymer composition can have relatively thin walls and can possess excellent impact resistance strength and high temperature performance. The polymer composition also displays excellent creep and fatigue properties. In addition, the polymer composition can be formulated to have excellent electrical properties.

For exemplary purposes only, in one aspect, the long fiber-reinforced polymer composition can be used to produce components in various different electrical devices and systems.

In certain embodiments, for instance, the device may be an electronic module that contains a housing that receives one or more electronic components (e.g., printed circuit board, antenna elements, radio frequency sensing elements, sensors, light sensing and/or transmitting elements (e.g., fibers optics), cameras, global positioning devices, etc.). The housing may, for instance, include a base that contains a sidewall extending therefrom. A cover may also be supported on the sidewall of the base to define an interior within which the electronic component(s) are received and protected from the exterior environment. Regardless of the particular configuration of the module, the polymer composition of the present invention may be used to form all or a portion of the housing and/or cover. In one embodiment, for instance, the polymer composition of the present invention may be used to form the base and sidewall of the housing. In such embodiments, the cover may be formed from the polymer composition of the present invention or from a different material, such as a metal component (e.g., aluminum plate).

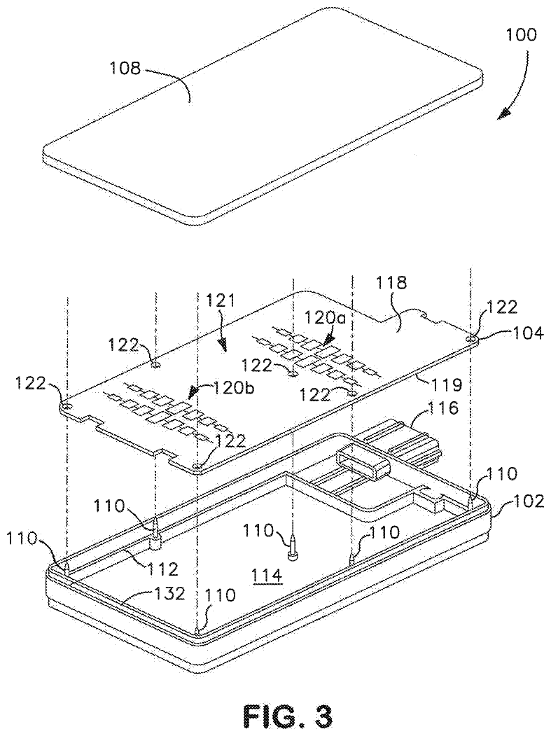

Referring to FIG. 3, for instance, one particular embodiment of an electronic module 100 is shown that may incorporate the polymer composition of the present invention. The electronic module 100 includes a housing 102 that contains sidewalls 132 extending from a base 114. If desired, the housing 102 may also contain a shroud 116 that can accommodate an electrical connector (not shown). Regardless, a printed circuit board (“PCB”) is received within the interior of the module 100 and attached to housing 102. More particularly, the circuit board 104 contains holes 122 that are aligned with and receive posts 110 located on the housing 102. The circuit board 104 has a first surface 118 on which electrical circuitry 121 is provided to enable radio frequency operation of the module 100. For example, the RF circuitry 121 can include one or more antenna elements 120a and 120b. The circuit board 104 also has a second surface 119 that opposes the first surface 118 and may optionally contain other electrical components, such as components that enable the digital electronic operation of the module 100 (e.g., digital signal processors, semiconductor memories, input/output interface devices, etc.). Alternatively, such components may be provided on an additional printed circuit board. A cover 108 may also be employed that is disposed over the circuit board 104 and attached to the housing 102 (e.g., sidewall) through known techniques, such as by welding, adhesives, etc., to seal the electrical components within the interior. As indicated above, the polymer composition may be used to form all or a portion of the cover 108 and/or the housing 102.

The electronic module may be used in a wide variety of applications. For example, the electronic module may be employed in an automotive vehicle (e.g., electric vehicle). When used in automotive applications, for instance, the electronic module may be used to sense the positioning of the vehicle relative to one or more three-dimensional objects. In this regard, the module may contain radio frequency sensing components, light detection or optical components, cameras, antenna elements, etc., as well as combinations thereof. For example, the module may be a radio detection and ranging (“radar”) module, light detection and ranging (“lidar”) module, camera module, global positioning module, etc., or it may be an integrated module that combines two or more of these components. Such modules may thus employ a housing that receives one or more types of electronic components (e.g., printed circuit board, antenna elements, radio frequency sensing devices, sensors, light sensing and/or transmitting elements (e.g., fibers optics), cameras, global positioning devices, etc.). In one embodiment, for example, a lidar module may be formed that contains a fiber optic assembly for receiving and transmitting light pulses that is received within the interior of a housing/cover assembly in a manner similar to the embodiments discussed above. Similarly, a radar module typically contains one or more printed circuit boards having electrical components dedicated to handling radio frequency (RF) radar signals, digital signal processing tasks, etc.

The electronic module may also be employed in a 5G system. For example, the electronic module may be an antenna module, such as macrocells (base stations), small cells, microcells or repeaters (femtocells), etc. As used herein, “5G” generally refers to high speed data communication over radio frequency signals. 5G networks and systems are capable of communicating data at much faster rates than previous generations of data communication standards (e.g., “4G, “LTE”). Various standards and specifications have been released quantifying the requirements of 5G communications. As one example, the International Telecommunications Union (ITU) released the International Mobile Telecommunications-2020 (“IMT-2020”) standard in 2015. The IMT-2020 standard specifies various data transmission criteria (e.g., downlink and uplink data rate, latency, etc.) for 5G. The IMT-2020 Standard defines uplink and downlink peak data rates as the minimum data rates for uploading and downloading data that a 5G system must support. The IMT-2020 standard sets the downlink peak data rate requirement as 20 Gbit/s and the uplink peak data rate as 10 Gbit/s. As another example, 3^{rd} Generation Partnership Project (3GPP) recently released new standards for 5G, referred to as “5G NR.” 3GPP published “Release 15” in 2018 defining “Phase 1” for standardization of 5G NR. 3GPP defines 5G frequency bands generally as “Frequency Range 1” (FR1) including sub-6 GHz frequencies and “Frequency Range 2” (FR2) as frequency bands ranging from 20-60 GHz. However, as used herein “5G frequencies” can refer to systems utilizing frequencies greater than 60 GHz, for example ranging up to 80 GHz, up to 150 GHz, and up to 300 GHz. As used herein, “5G frequencies” can refer to frequencies that are about 1.8 GHz or more, in some embodiments about 2.0 GHz or more, in some embodiments about 3.0 GHz or higher, in some embodiments from about 3 GHz to about 300 GHz, or higher, in some embodiments from about 4 GHz to about 80 GHz, in some embodiments from about 5 GHz to about 80 GHz, in some embodiments from about 20 GHz to about 80 GHz, and in some embodiments from about 28 GHz to about 60 GHz.

5G antenna systems generally employ high frequency antennas and antenna arrays for use in a 5G component, such as macrocells (base stations), small cells, microcells or repeaters (femtocell), etc., and/or other suitable components of 5G systems. The antenna elements/arrays and systems can satisfy or qualify as “5G” under standards released by 3GPP, such as Release 15 (2018), and/or the IMT-2020 Standard. To achieve such high speed data communication at high frequencies, antenna elements and arrays generally employ small feature sizes/spacing (e.g., fine pitch technology) that can improve antenna performance. For example, the feature size (spacing between antenna elements, width of antenna elements) etc. is generally dependent on the wavelength (“λ”) of the desired transmission and/or reception radio frequency propagating through the substrate on which the antenna element is formed (e.g., nλ/4 where n is an integer). Further, beamforming and/or beam steering can be employed to facilitate receiving and transmitting across multiple frequency ranges or channels (e.g., multiple-in-multiple-out (MIMO), massive MIMO). The high frequency 5G antenna elements can have a variety of configurations. For example, the 5G antenna elements can be or include co-planar waveguide elements, patch arrays (e.g., mesh-grid patch arrays), other suitable 5G antenna configurations. The antenna elements can be configured to provide MIMO, massive MIMO functionality, beam steering, etc. As used herein “massive” MIMO functionality generally refers to providing a large number transmission and receiving channels with an antenna array, for example 8 transmission (Tx) and 8 receive (Rx) channels (abbreviated as 8×8). Massive MIMO functionality may be provided with 8×8, 12×12, 16×16, 32×32, 64×64, or greater.

The antenna elements may be fabricated using a variety of manufacturing techniques. As one example, the antenna elements and/or associated elements (e.g., ground elements, feed lines, etc.) can employ fine pitch technology. Fine pitch technology generally refers to small or fine spacing between their components or leads. For example, feature dimensions and/or spacing between antenna elements (or between an antenna element and a ground plane) can be about 1,500 micrometers or less, in some embodiments 1,250 micrometers or less, in some embodiments 750 micrometers or less (e.g., center-to-center spacing of 1.5 mm or less), 650 micrometers or less, in some embodiments 550 micrometers or less, in some embodiments 450 micrometers or less, in some embodiments 350 micrometers or less, in some embodiments 250 micrometers or less, in some embodiments 150 micrometers or less, in some embodiments 100 micrometers or less, and in some embodiments 50 micrometers or less. However, it should be understood that feature sizes and/or spacings that are smaller and/or larger may also be employed. As a result of such small feature dimensions, antenna configurations and/or arrays can be achieved with a large number of antenna elements in a small footprint. For example, an antenna array can have an average antenna element concentration of greater than 1,000 antenna elements per square centimeter, in some embodiments greater than 2,000 antenna elements per square centimeter, in some embodiments greater than 3,000 antenna elements per square centimeter, in some embodiments greater than 4,000 antenna elements per square centimeter, in some embodiments greater than 6,000 antenna elements per square centimeter, and in some embodiments greater than about 8,000 antenna elements per square centimeter. Such compact arrangement of antenna elements can provide a greater number of channels for MIMO functionality per unit area of the antenna area. For example, the number of channels can correspond with (e.g., be equal to or proportional with) the number of antenna elements.

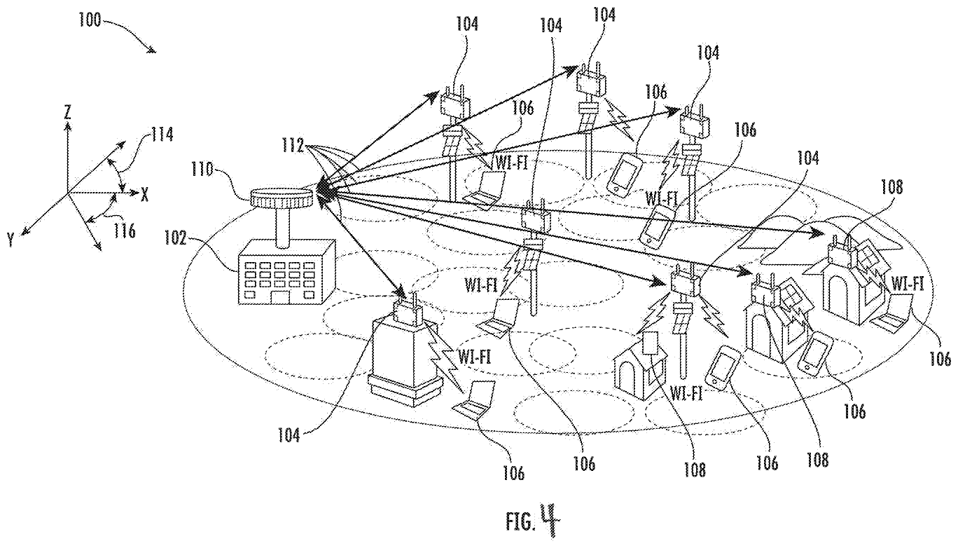

Referring to FIG. 4, for example, a 5G antenna system 100 can include a base station 102, one or more relay stations 104, one or more user computing devices 106, one or more Wi-Fi repeaters 108 (e.g., “femtocells”), and/or other suitable antenna components for the 5G antenna system 100. The relay stations 104 can be configured to facilitate communication with the base station 102 by the user computing devices 106 and/or other relay stations 104 by relaying or “repeating” signals between the base station 102 and the user computing devices 106 and/or relay stations 104. The base station 102 can include a MIMO antenna array 110 configured to receive and/or transmit radio frequency signals 112 with the relay station(s) 104, Wi-Fi repeaters 108, and/or directly with the user computing device(s) 106. The user computing device 306 is not necessarily limited by the present invention and include devices such as 5G smartphones. The MIMO antenna array 110 can employ beam steering to focus or direct radio frequency signals 112 with respect to the relay stations 104. For example, the MIMO antenna array 110 can be configured to adjust an elevation angle 114 with respect to an X-Y plane and/or a heading angle 116 defined in the Z-Y plane and with respect to the Z direction. Similarly, one or more of the relay stations 104, user computing devices 106, Wi-Fi repeaters 108 can employ beam steering to improve reception and/or transmission ability with respect to MIMO antenna array 110 by directionally tuning sensitivity and/or power transmission of the device 104, 106, 108 with respect to the MIMO antenna array 110 of the base station 102 (e.g., by adjusting one or both of a relative elevation angle and/or relative azimuth angle of the respective devices).

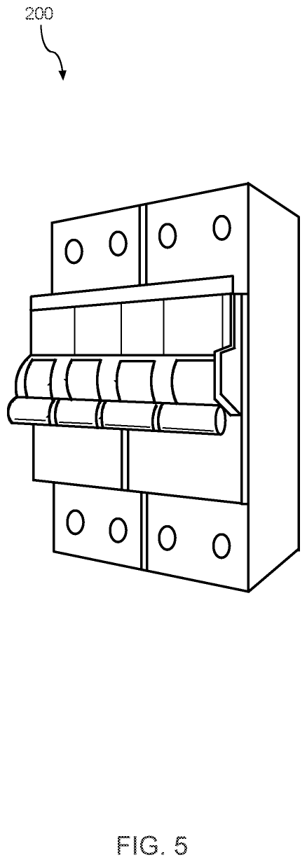

In other embodiments, the long fiber-reinforced polymer composition of the present disclosure can be used to produce housings for electrical components that may be contained in industrial settings, residential settings, or within all different types of vehicles including automobiles, trucks, planes, trains, and the like. For example, referring to FIG. 5, a circuit breaker 200 is shown. The circuit breaker contains electrical components that are placed within a circuit. The flame retardant and long fiber-reinforced polymer composition of the present disclosure can be used to construct an insulating component within the circuit breaker 200 or can be used to construct all or a portion of the housing of the circuit breaker 200.

In still another embodiment, the polymer composition is used to produce a structural component of a battery, such as a side support, a cover, a separator, or a bottom support. The battery, for instance, can comprise a lithium ion battery or an array of lithium ion batteries. The long fiber reinforced polymer composition is particularly well suited to producing battery housings, covers, trays, or bracketing. Of particular advantage, the long fiber reinforced polymer composition displays exceptionally low warpage and shrinkage.

As described above, the long fiber reinforced polymer composition of the present disclosure can display excellent flame resistant characteristics. The flammability of the composition can be characterized in accordance with Underwriter's Laboratory Bulletin 94 entitled “Test for Flammability of Plastic Materials, UL 94.” Several ratings can be applied based on the time to extinguish (total flame time of a set of five specimens) and the ability of the composition to resist dripping. The test can be applied to various different specimens having different thicknesses.

| Vertical | |
|---|---|
| Ratings | Requirements |
| V-0 | Specimens must not burn with flaming combustion for more than |
| | 10 seconds after either test flame application. |
| | Total flaming combustion time must not exceed 50 seconds for |
| | each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 30 seconds after removal of the test flame. |
| V-1 | Specimens must not burn with flaming combustion for more than |
| | 30 seconds after either test flame application. |
| | Total flaming combustion time must not exceed 250 seconds for |
| | each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 60 seconds after removal of the test flame. |
| V-2 | Specimens must not burn with flaming combustion for more than |
| | 30 seconds after either test flame application. |
| | Total flaming combustion time must not exceed 250 seconds for |
| | each set of 5 specimens. |
| | Specimens must not burn with flaming or glowing combustion |
| | up to the specimen holding clamp. |
| | Specimens can drip flaming particles that ignite the cotton. |
| | No specimen can have glowing combustion remain for longer |
| | than 60 seconds after removal of the test flame. |

Long fiber reinforced polymer compositions of the present disclosure can display a V-0 rating at thicknesses of 2 mm or less.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A fiber-reinforced polymer composition comprising:
a polymer matrix comprising a thermoplastic polymer, the polymer matrix comprising from about 30 wt. % to about 90 wt. % of the polymer composition;
a plurality of long reinforcing fibers that are distributed within the polymer matrix, wherein the fibers comprise from about 10 wt. % to about 70 wt. % of the polymer composition; and
a flame retardant system comprising a metal phosphinate and a synergist comprising a melamine metal phosphate or a melamine poly(metal phosphate), the flame retardant system being present in the polymer composition in an amount greater than about 12% by weight, such as greater than about 18.5% by weight.

2. The fiber-reinforced polymer composition of claim 1, wherein, at a thickness of 1 millimeter, the composition exhibits a VO rating as determined in accordance with UL94 and displays a comparative tracking index of 600 volts or more as determined in accordance with IEC 60112:2020.

3. The fiber-reinforced polymer composition of claim 1, wherein the polymer composition exhibits a Limiting Oxygen Index of about 25 or more as determined in accordance with ISO 4589:2017.

4. The fiber-reinforced polymer composition of claim 1, wherein the polymer composition exhibits a total flame time of about 250 seconds or less in accordance with UL94.

5. The fiber-reinforced polymer composition of claim 1, wherein the synergist comprises melamine poly(zinc phosphate).

6. The fiber-reinforced polymer composition of claim 1, wherein the synergist is present in the polymer composition in an amount of from about 4 wt. % to about 9 wt. %.

7. The fiber-reinforced polymer composition of claim 1, wherein the fibers include glass fibers.

8. The fiber-reinforced polymer composition of claim 1, wherein the fibers are spaced apart and aligned in a substantially similar direction.

9. The fiber-reinforced polymer composition of claim 1, further comprising a stabilizer package comprising an antioxidant, a heat stabilizer, and optionally a light stabilizer, the heat stabilizer comprising a copper complex.

10. The fiber-reinforced polymer composition of claim 9, wherein the heat stabilizer comprises iodobis(triphenylphosphino) copper.

11. The fiber-reinforced polymer composition of claim 9, wherein the antioxidant comprises a reaction product of 2,4-di-tert-butlyphenol, phosphorous trichloride, and 1,1′-biphenyl.

12. The fiber-reinforced polymer composition of claim 9, wherein the light stabilizer is included in the stabilizer package and comprises a benzendicarboxamide.

13. The fiber-reinforced polymer composition of claim 1, wherein the thermoplastic polymer comprises one or more polyamides.

14. The fiber-reinforced polymer composition of claim 1, wherein the metal phosphinate has the general formula (I) and/or formula (II): 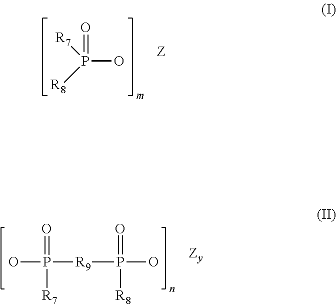
wherein,
R₇ and R₈ are, independently, hydrogen or substituted or unsubstituted, straight chain, branched, or cyclic hydrocarbon groups having 1 to 6 carbon atoms;
R₉ is a substituted or unsubstituted, straight chain, branched, or cyclic C₁-C₁₀ alkylene, arylene, arylalkylene, or alkylarylene group;
Z is Mg, Ca, Al, Sb, Sn, Ge, Ti, Zn, Fe, Zr, Ce, Bi, Sr, Mn, Li, Na, K, and/or a protonated nitrogen base;
y is from 1 to 4;
n is from 1 to 4; and
m is from 1 to 4.

15. The fiber-reinforced polymer composition of claim 1, wherein the phosphinate is a metal salt of dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid, hypophosphoric acid, or a mixture thereof.

16. The fiber-reinforced polymer composition of claim 1, wherein the flame retardant system is free of zinc borate.

17. The fiber-reinforced polymer composition of claim 13, wherein the polyamide is an aliphatic polyamide.

18. The fiber-reinforced polymer composition of claim 17, wherein the aliphatic polyamide is nylon-6, nylon-6,6, a copolymer thereof, or a combination thereof.

19. The fiber-reinforced polymer composition of claim 17, wherein the aliphatic polyamide is present with a semi-aromatic polyamide or a wholly aromatic polyamide.

20. A fiber-reinforced polymer composition comprising:
a polymer matrix comprising a thermoplastic polymer, the polymer matrix comprising from about 40 wt. % to about 90 wt. % of the polymer composition;
a plurality of long reinforcing fibers that are distributed within the polymer matrix, wherein the fibers comprise from about 10 wt. % to about 40 wt. % of the polymer composition;
a flame retardant system comprising a metal phosphinate and a synergist comprising a melamine metal phosphate or a melamine poly(metal phosphate); and
a stabilizer package comprising an antioxidant, a heat stabilizer, and optionally a light stabilizer, the heat stabilizer comprising a copper complex and wherein the composition exhibits a comparative tracking index of 600 volts or more as determined in accordance with IEC 60112:2020.

21. An electrical connector that comprises opposing walls between which a passageway is defined for receiving a contact pin, wherein at least one of the walls contains the fiber-reinforced polymer composition as defined in claim 20.
